(19) United States
(12) Patent Application Publication
(10) Pub. No.: US 2016/0274582 A1
(43) Pub. Date: Sep. 22, 2016

(54) METHOD FOR OPTIMIZING THE ORIENTATION OF A REMOTE-CONTROL DEVICE WITH RESPECT TO A ROLLING DRONE

(71) Applicant: PARROT, Paris (FR)

(72) Inventors: Luc Banda, Fontenay-sous-Bois (FR); Henri Seydoux, Paris (FR)

(21) Appl. No.: 15/067,016

(22) Filed: Mar. 10, 2016

(30) Foreign Application Priority Data
Mar. 16, 2015 (FR) 15 52124

(51) Int. Cl. G05D 1/00; B64C 39/02; H04W 4/02

(52) U.S. Cl. CPC G05D 1/0038; H04W 4/026; G05D 1/0022; B64C 39/024; G05D 1/0016; B64C 2201/146; B64C 2201/127

(57) ABSTRACT

The remote-control device (16) comprises an antenna for the radio link with the drone, and a touch screen (20) displaying an image captured by the camera of the drone. The method comprises the steps of: a) determination of the active antenna (28b); b) determination of the device model used; c) search, in a table of an applicative piloting software, for information of relative orientation with respect to the active antenna with respect to the device body; d) display of the image on the touch screen so that the top of a scene captured by the camera of the drone appears (A) to the user at the bottom of the screen (20) if the orientation of the antenna with respect to the device body does not correspond to the direction (D) of the drone, and appears (B) to the user at the top of the screen (20) if the orientation of the antenna with respect to the device body corresponds to the direction (D) of the drone, so as to produce an anti-natural display (A) leading the user to return the device (A′), hence placing the antenna in the direction (D) of the drone.

The invention relates to the remote piloting of motorized devices, generally referred to as “drones” hereinafter.

They may be flying drones, in particular rotary-wing drones such as helicopters, quadricopters and the like. But the invention is however not limited to the piloting of and data exchange with flying devices; it also applies to rolling devices progressing on the ground under the control of a remote operator, wherein the term “drone” has of course to be understood in its most general meaning.

A typical example of flying drone is the AR.Drone 2.0 or the Bebop (registered trademarks) from Parrot SA, Paris, France, which are quadricopters equipped with a series of sensors (accelerometers, gyrometers, altimeters), a front video camera capturing an image of the scene towards which the drone is directed, and a vertical-view camera capturing an image of the overflown ground. Another type of drone to which the invention may apply is the Jumping Sumo, also from Parrot SA, which is a remote-controlled rolling and jumping toy provided with accelerometer and gyrometer sensors and with a front video camera.

The WO 2010/061099 A2, EP 2 364 757 A1, EP 2 450 862 A1 and EP 2 613 213 A1 (Parrot) describe the principle of piloting a drone through a touch-screen multimedia telephone or tablet having integrated accelerometers, for example a smartphone of the iPhone type or a tablet of the iPad type (registered trademarks), executing a specific remote-control applicative software, such as, in the above example, the mobile application AR Free Flight (registered trademark).

Hereinafter, the term “remote control” or “device” will be generally used to refer to this remote-control means, but this term must not be understood in its narrow meaning; quite the contrary, it also includes the functionally equivalent devices, in particular all the portable devices provided with at least one visual display screen and wireless data exchange means, such as smartphone, multimedia player with no phone functions, game console, etc.

The front video camera can be used for an “immersive mode” piloting of the drone, i.e. where the operator uses the image of the camera in the same way as if he were himself on board the drone. It may also serve to capture sequences of images of a scene towards which the drone is directed, the operator using the drone in the same way as a camera that, instead of being held in hand, would be borne by the drone. The collected images can be recorded, put online on web sites, sent to other Internet users, shared on social networks, etc.

The device incorporates the various control elements required for the detection of the piloting commands and the bidirectional exchange of data via a radio link of the Wi-Fi (IEEE 802.11) or Bluetooth wireless local network type directly established with the drone. Its touch screen displays the image captured by the front camera of the drone, with, in superimposition, a certain number of symbols allowing the control of the flight and the activation of commands by simple contact of the user's finger on the touch screen. This bidirectional radio link comprises an downlink (from the drone to the device) to transmit data frames containing the video flow coming from the camera and drone flight data or state indicators, and an uplink (from the device to the drone) to transmit the piloting commands.

It will be understood that the quality of the radio link between the remote control and the drone is an essential parameter, in particular to ensure a satisfactory range and with the less latency possible. The volumes of data transmitted are indeed significant, in particular due to the very high need in video flow of the downlink (typically of the order of 2.5 to 3 Mbit/second), and any degradation of quality of the radio link will have an impact on the framerate allocated to the commands by the uplink, from which it will follow a degradation of the quality of transmission of the uplink and a reduction of the radio range, creating a risk of sporadic losses of frames containing the commands produced by the device, leading as a consequence to a control of the drone becoming very difficult.

At the remote-control device, the radio link uses an antenna incorporated to the device that, in emission, radiates the power of the HF emitter circuit supporting the uplink and, in reception, picks-up the signals emitted by the drone, in particular the video flow and flight data signals.

With this type of remote-control device, the user pilots the drone by holding the device, typically with two hands, by gripping the device on each side between palm and thumb or between index finger and thumb, the thumbs placed on the screen, so as to be able to pilot the drone by more or less inclining the device according to the pitch and roll axes so that the drone replicates the same movement, and by controlling various parameters by touching with a finger mobile icons or buttons displayed on the touch screen of the device.

It will be understood that, in such conditions, the hands are naturally placed in the corners of the device case, covering more or less space on the edges. And, it is generally at that place that are placed the WiFi and/or Bluetooth antennas of the device (the WiFi and Bluetooth antennas, distinct from each other, being not necessarily located at the same place).

The radio waves of the Bluetooth and WiFi links, which are located in very high frequency bands (respectively of the order of 2.4 GHz and 5.1-5.7 GHz) are very strongly attenuated by the human body, and in this case the hands of the user if these latter are near the antenna used by the device to communicate with the drone.

In practice, the location of these antennas may significantly vary from one model of device to another, so that the power of the signal radiated by the device towards the drone, as the sensitivity of reception of the signal received from the drone, will be very dependent on the position and orientation of the device the user holds in his hands. More precisely, the device being generally held with its screen in “landscape” position, if the antenna is located on a long side of the device and is on the side turned towards the drone, this position will be optimal. On the other hand, if the device is held in the reverse direction, i.e. with the antenna on the side the closest to the user, this configuration is particularly unfavourable not only because the antenna will be turned towards the user and not towards the drone, but also because the user's body will strongly disturb the propagation of the radio waves by mass screen effect, leading to a significant degradation of the quality of the radio link.

Comparably, if the antenna is located in a region close to one corner of the device, according to the way the user holds this device, the case could be that this antenna is located just at the place of his thumb, which will then act as a screen and significantly hamper the propagation of the radio waves in the region of the antenna.

It is hence observed that the power of the signal radiated towards the drone, and the sensitivity of the signal received—hence as a consequence the range and the latency of the radio link—are very dependent on the way the user holds the remote-control device, in particular the way he has oriented this device and he holds it in its hands.

The object of the invention is to solve this problem, by proposing a mean to optimize the orientation of the remote-control device with respect to the drone and, as a consequence, to maximize the radio energy radiated by the remote control (in emission) and the level of the radio signal picked-up (in reception).

The basic idea of the invention consists, after having recognised the model of remote control used (which gives the position of the active antenna used with this model), to do so that the position of the antenna is that which provides the best radio link, i.e. the main lobe of the radiation pattern of the active antenna is directed forward (i.e. towards the drone and not towards the user), and/or that the antenna located in a corner of the device case is not covered by a thumb or by the hand palm.

This problem is tackled in particular in the WO 2014/143678 A1, which proposes to give a user indications to reorient its portable phone, possibly usable for the remote control of a drone, based on a table of conditions associated with antenna configuration parameters.

In the solution proposed by the present invention, the device does not strictly speaking deliver to the user instructions of reorientation of the device, but controls the display of the image on the touch screen so that the top of a scene captured by the camera of the drone appears to the user:
at the bottom of the screen, if the orientation of the active antenna does not correspond to the direction in which the drone is oriented, and
at the top of the screen, if the orientation of the active antenna corresponds to the direction in which the drone is oriented.

From then one:
in the first case, the image will be displayed upside down and the user will naturally return the remote-control device to restore a correct image—and this inversion will precisely do so that the antenna will be oriented in the optimal position, turned forward hence towards the drone, instead of being turned towards the user;
in the second case, the user (to whom nothing has been asked and who didn't notice anything) will normally use the device to remote control the drone.

More precisely, the invention proposes a method for optimizing the orientation of a remote-control device with respect to a flying or rolling drone remote controlled by this device, the remote-control device and the drone communicating between each other through a radio link.

As known, in particular according to the above-mentioned EP 2 613 213 A1, the drone comprises an on-board video camera, and emitter-receiver means for said radio link. The remote-control device comprises a device body adapted to be held in hand by a user, emitter-receiver means for said radio link, comprising at least one emitting-receiving antenna placed at a predetermined position with respect to the device body, and a touch screen adapted to display an image captured by the camera of the drone and transmitted to the device via said radio link, and to detect a contact on the surface of the screen of at least one finger of the user holding the device body.

Characteristically of the invention, the method comprises the following steps:
a) determination of the active antenna used by the emitter-receiver means of the device for said radio link;
b) determination of the model of the device used;
c) search in a table for information of relative orientation of the active antenna with respect to the device body, said table being a table of a piloting software previously loaded and memorized in the device, the respective entries of said table giving, for each device model liable to be used to remote control the drone, the corresponding information of relative orientation of the antenna of this model; and
d) display of the image on the touch screen so that the top of a scene captured by the camera of the drone appears to the user at the bottom of the screen if the relative orientation of the active antenna with respect to the device body does not correspond to the direction in which the drone is oriented, and appears to the user at the top of the screen if the relative orientation of the active antenna with respect to the device body corresponds to the direction in which the drone is oriented.

The orientation information of the active antenna with respect to the device body is advantageously Boolean information indicating on which side is located the antenna with respect to a median axis of the device body, this median axis extending between two opposite sides of the device adapted to be each held by a respective hand of the user.

In this case, in a preferential embodiment of the invention, the step d) comprises an unconditional forcing of the direction of display of the image on the touch screen so that, with respect to said median axis, the top of a scene captured by the camera of the drone is located on the same side of the screen as the side where the active antenna is located.

In all the cases, if the search step c) does not allow to find an entry corresponding to the identifier of the device model, the step d) is not executed and a warning message is displayed on the device screen.

When the emitter-receiver means of the device comprise emitter-receiver means adapted to operate in a plurality of distinct radio bands corresponding to a plurality of different respective antennas, then the respective entries of said table give the information of relative orientation of the active antenna for each device model liable to be so used for each radio band liable to be used by a given model, and the step a) of determination of the active antenna comprises the selection, among the plurality of antennas of the device, of the antenna compatible with the radio band used by the emitter-receiver means of the drone.

In another embodiment of the method, it is further provided a previous step of determination of information of relative orientation of the device with respect to the user, and the step d) is conditionally executed as a function of the information of relative orientation of the device with respect to the user. The determination of the information of relative orientation of the device with respect to the user may in particular be implemented by accelerometer or inclinometer measurement of an absolute orientation of the device body, or by detection of the region of the screen surface in contact with the finger(s) of the user holding the device body.

An exemplary embodiment of the present invention will now be described, with reference to the appended drawings in which the same references denote identical or functionally similar elements throughout the figures.

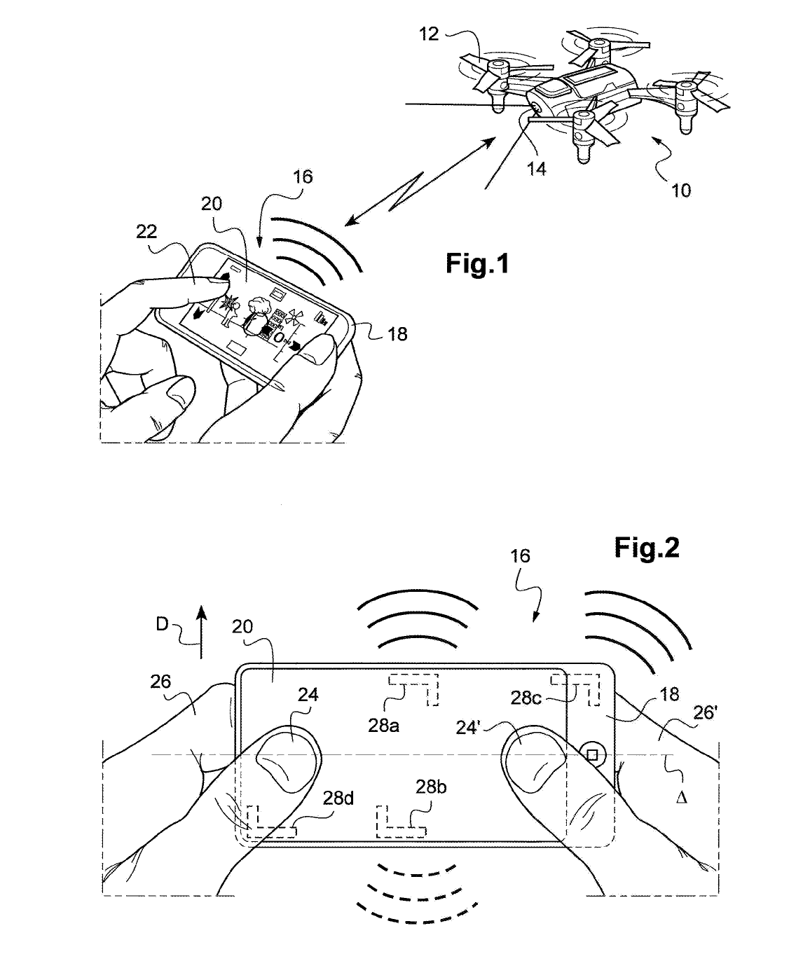

FIG. 1 is a general view showing a drone piloted by a remote-control device.

FIG. 2 shows the remote-control device held in hand by the user during the piloting of the drone.

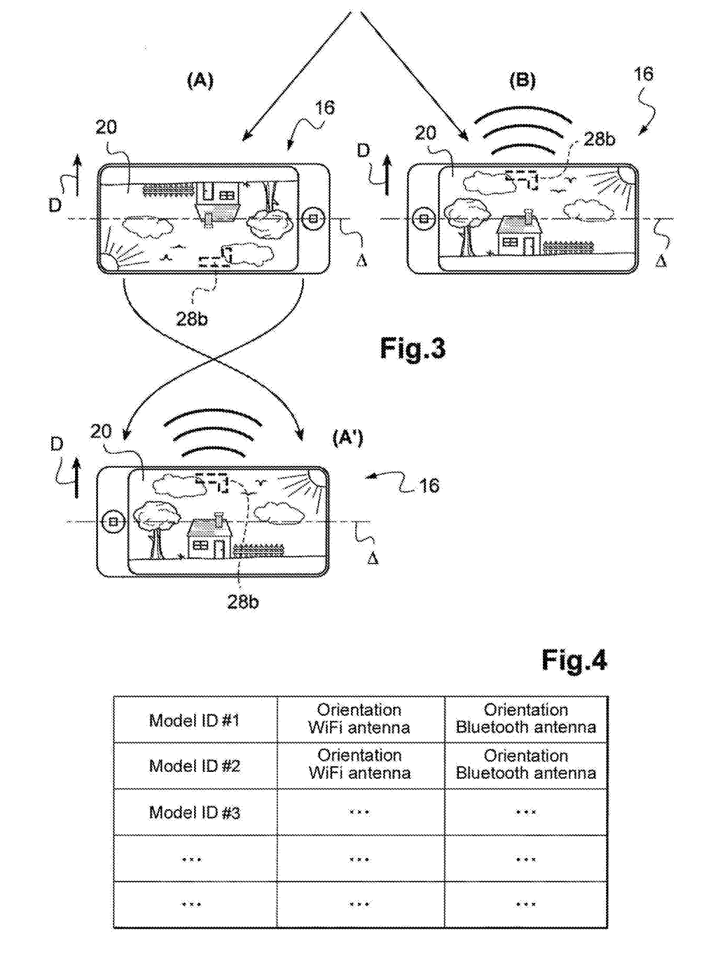

FIG. 3 illustrates the actions taken by the implementation of the method of the invention.

FIG. 4 is an example of table giving the positions of the antennas for different models of devices.

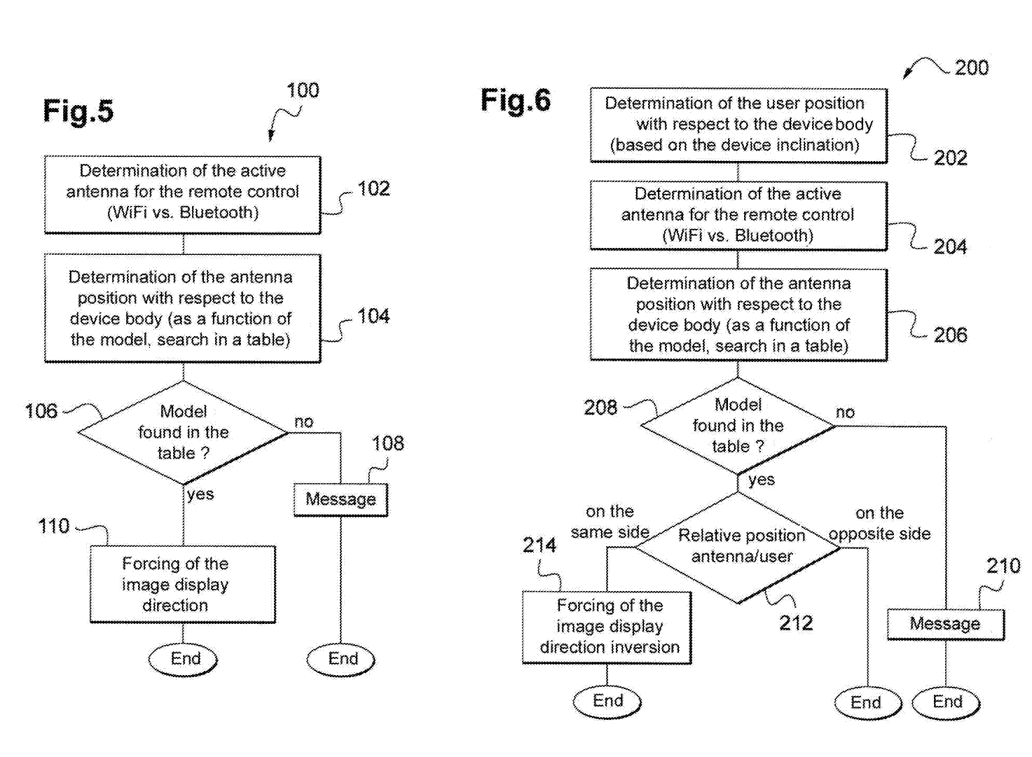

FIG. 5 is a general flowchart showing the successive steps of the method of the invention, in a preferential embodiment.

FIG. 6 is a general flowchart of a variant of implementation of the invention.

In FIG. 1, the reference 10 generally denotes a drone, which is for example a quadricopter such as the Bebop Drone model of Parrot SA, Paris, France. This drone includes four coplanar rotors 12 whose motors are piloted independently from each other by an integrated navigation and attitude control system. It is provided with a front-view camera 14 allowing to obtain an image of the scene towards which the drone is directed, for example a high-definition wide-angle camera with a CMOS sensor of resolution 1920×1080 pixels with a refresh frequency of the video flow of 30 fps (frame per second).

The drone 10 is piloted by a remote remote-control device 16 such as a touch-screen multimedia telephone or tablet having integrated accelerometers, for example a smartphone of the iPhone type (registered trademark) or another, or a tablet of the iPad type (registered trademark) or another. It is a standard device that is not modified, except the loading of a specific applicative software such as the mobile application AR Free Flight (registered trademark) to control the piloting of the drone 10 and the visualization of the images taken by the on-board camera 14.

The device 16 comprises a body 18 and a touch screen 20 displaying the image of the scene captured by the on-board camera of the drone 14 with, in superimposition, a certain number of symbols allowing the activation of piloting commands (moving up/down, etc.) by simple contact of a finger 22 of the user on the symbols displayed on the screen. The device 16 is also provided with inclination sensors allowing to control the attitude of the drone by imparting to the device corresponding inclinations according to the roll and pitch axes to make the drone move forward or rearward. The actions imparted to the device by the user are interpreted by the applicative software that transforms them into command signals for the drone.

As can be seen in FIG. 2, which illustrates the device 16 held in hand by the user, the latter normally holds the device in “landscape” mode, which corresponds to the format of the camera 14 of the drone and hence of the image that is reproduced on the screen 20. For that purpose, the device 16 is generally strongly held by two hands between the thumb 24, 24′ and the index or the palms 26, 26′, so that it can be inclined in pitch and roll in order for the drone to replicate these inclinations and to produce corresponding displacements, forward or rearward or aside.

The references 28a to 28d illustrate different possible configurations of the active antenna, incorporated to the body 18 of the device, for the exchange of data with the drone by the radio link:
if the antenna is in the illustrated position 28a, this configuration is optimal, because the antenna is turned towards the drone (the latter being in the direction D) and is not hidden by the user's fingers;
on the other hand, if the active antenna is located at the position 28b, on the other side of the median longitudinal axis Δ of the device 16, the antenna will radiate towards the user, hence far less efficiently;
in the case where, for the device model considered, the antenna is located in one corner of the device body 18, at the position illustrated in 28c, this position is optimal, because it is turned towards the drone (direction D) and is not hidden by the user's fingers;
on the other hand, if the antenna is in an opposite corner, as illustrated in 28d, this configuration is particularly unfavourable because not only the antenna is turned towards the user instead of being turned towards the drone, but in addition the user's fingers 24, 26 hide it and strongly disturb the propagation of the radio waves.

The basic idea of the invention lies in the fact that, if the antenna is in an unfavourable configuration (as in 28b and 28d), then in this latter case, it is just necessary to return flat by half a turn the body 18 of the device 16 to restore the optimal configuration, i.e. this simple operation will allow to switch from the position 28b to the position 28a, or from the position 28d to the position 28c.

It is of course possible to measure for example the level of the signal received by the antenna (RSSI level) and to ask the user to test the possible positions so that he chooses the one which provides the best level of reception.

The invention proposes another solution to this problem, which does not imply to measure the level of the signal received, and can hence be used before radio data have been exchanged between the device and the drone.

The basic idea consists, if the place where the active antenna is located within the device body is known a priori, in determining, from a table giving such information as a function of the device model, information of relative orientation of the active antenna with respect to the device body and:
if the antenna is oriented “to the bad side”, i.e. turned towards the user, then doing so that the display of the image is inverted (top/bottom), leading the user to spontaneously return by half a turn the device he holds in his hands to restore the correct direction of the image that is presented to him;
if the antenna is “on the good side”, i.e. turned towards the drone in a region that is free from any contact with the user's hand, doing so that the display is non-inverted and letting the user continue to use the device.

Concretely, the preferential solution consists in managing the display so that the “top” of the image displayed is systematically located on the same side (with respect to a median horizontal axis of the device) as the antenna that will be used. That way, if the antenna is located “on the bad side”, the display will be that way shown “upside down” from the point of view of the user, whereas, in the opposite case, it will be shown “the right way up”.

This principle is illustrated in FIG. 3: in (A) is illustrated the case where the antenna 28b is located, with respect to the longitudinal axis Δ of the device, on the side turned towards the user and not on the side turned towards the drone (direction D): in this case, the display is forced to an “anti-natural mode” with inversion of the image. The user will then spontaneously return the device (half a turn flat) up to the position (A′) where the antenna 28b will be suitably oriented, in the direction D of the drone, wherein the display has become again “natural” for the user.

In the opposite case where, at the beginning of the process, the antenna 28b is, with respect to the longitudinal axis Δ, on the opposite side with respect to the user, i.e. on the side turned towards the drone (direction D), this configuration (B) is considered as optimal and no particular action is taken, the display on the screen 20 is kept “natural”.

For the implementation of this method, it is necessary to know a priori the relative orientation of the antenna with respect to the device body 18, for each conceivable device model.

For that purpose, a table is memorized within the applicative piloting software previously loaded and memorized in the remote-control device.

This software being a versatile software, compatible with multiple models of devices, the table includes, as illustrated in FIG. 4, a plurality of headings with, for each one, an entry consisted by a model identifier and fields giving, for each model, the location of the WiFi antenna and of the Bluetooth antenna. The location information gives the relative orientation of the antenna with respect to the device body, and can be simply Boolean data indicating on which side is located the antenna with respect to the median axis Δ of the device body, the axis being defined as the axis extending between the two sides between which the device is held in hand by a user looking at the screen in “landscape” mode.

FIG. 5 is a flowchart describing the chaining 100 of the different steps of implementation of this method, in a preferential embodiment.

A first step (block 102) consists in determining which one of the antennas, WiFi or Bluetooth, will be used by the remote control according to the type of drone that it is desired to pilot (some of which operating in Bluetooth, other in WiFi).

Hence knowing the active antenna that will be used, the relative orientation of this active antenna with respect to the device body can then be determined (block 104), based on the table stored in memory giving, as a function of the device model, the position of this antenna with respect to the device body.

In the particular case in which the device model is not referenced in the table (block 106), no particular action is taken, except possibly displaying (block 108) a message to the user so that the latter tests the two possible orientations and determines by himself the most performant one, for example by observing the received signal level indicator that is displayed on the screen.

In all the other cases, the direction of display of the image on the screen is simply forced (block 110) in such a manner that, with respect to the median axis Δ of the device body, the top of a scene captured by the camera of the drone is located in all the cases on the same side of the screen as the side where the active antenna is located.

From then one, if the device is “well oriented” with respect to the drone (i.e. with the active antenna turned towards the drone and not towards the user), the image will be shown the right way up to the user, whereas, in the opposite case, it will be shown to him upside down: this inversion, as indicated hereinabove, constitutes a visual message of bad orientation, leading the user to spontaneously correct the situation by returning the device by half a turn flat to restore, from his point of view, a correct image.

FIG. 6 is a flowchart describing the chaining 200 of the different steps of implementation of this method, in another embodiment of the invention.

In this case, it is provided a first step (block 202) of determination of the relative position of the user with respect to the device body.

This position may be determined by inclinometer or accelerometer means incorporated to the device, giving the direction of the vertical (gravity) with respect to the device body. As it is supposed that the user is looking at the screen, the measurement of the device body orientation allows to determine on which side is the user with respect to the longitudinal axis Δ.

Other means may be used, for example detection of the contact of the user's fingers on the touch screen 20. With respect to the axis Δ, the side where the surface of contact of the fingers will be the most important will allow to determine the relative orientation of the device with respect to the user.

The following step (block 204) consists in determining which one of the antennas will be used by the remote control, WiFi or Bluetooth, according to the type of drone that it is desired to pilot (some of which operating in Bluetooth, other in WiFi).

Hence knowing the active antenna that will be used, the relative orientation of this active antenna with respect to the device body can then be determined (block 206), based on the table stored in memory giving, as a function the device model, the position of this antenna with respect to the device body.

In the particular case where the device model is not referenced in the table (block 208), no particular action is taken, except possibly displaying (block 210) a message to the user so that the latter tests the two possible orientations and determines by himself the most performant one, for example by observing the received signal level indicator that is displayed on the screen.

In all the other cases, the relative orientation of the device with respect to the user is compared to the relative orientation of the active antenna with respect to the device body (block 212):
if the antenna and the user are on the same side (case of the antennas 28b and 28d in FIG. 2), then the inversion of the direction of display of the image is forced (block 214), so that, without thinking, the user returns its device to make disappear this “anti-natural” display;
in the opposite case, the configuration is considered as optimal and no particular action is taken (configuration corresponding to the antennas 28a or 28c of FIG. 2).

1. A method for optimizing the orientation of a remote-control device with respect to a flying or rolling drone remote controlled by this device, the remote-control device and the drone communicating between each other through a radio link,
the drone (10) comprising:
an on-board video camera (14); and
emitter-receiver means for said radio link,
the remote-control device (10) comprising:
a device body (18), adapted to be held in hand by a user;
emitter-receiver means for said radio link, comprising at least one emitting-receiving antenna (28a, 28b, 28c, 28d) placed at a predetermined position with respect to the device body; and
a touch screen (20) adapted to display an image captured by the camera of the drone and transmitted to the device via said radio link, and to detect a contact on the surface of the screen of at least one users finger holding the device body,
characterized by the following steps:
a) determination (104) of the active antenna used by the emitter-receiver means of the device for said radio link;
b) determination of the device model used;
c) search (106) in a table for information of relative orientation of the active antenna with respect to the device body,
said table being a table of a piloting software previously loaded and memorized in the device,
the respective entries of said table giving, for each device model liable to be used to remote control the drone, the corresponding information of relative orientation of the antenna of this model; and
d) display of the image on the touch screen so that the top of a scene captured by the camera of the drone appears to the user at the bottom of the screen if the relative orientation of the active antenna with respect to the device body does not correspond to the direction in which the drone is oriented, and appears to the user at the top of the screen if the relative orientation of the active antenna with respect to the device body corresponds to the direction in which the drone is oriented.

2. The method of claim 1, wherein the information of orientation of the active antenna with respect to the device body is Boolean information indicating on which side is located the antenna with respect to a median axis (Δ) of the device body, this median axis extending between two opposite sides of the device adapted to be each held by a respective hand (24, 26; 24′, 28′) of the user.

3. The method of claim 2, wherein the step d) comprises an unconditional forcing of the direction of display of the image on the touch screen so that, with respect to said median axis, the top of a scene captured by the camera of the drone is located on the same side of the screen as the side where the active antenna is located.

4. The method of claim 1, wherein, if the search step c) does not allow to find an entry corresponding to the device model identifier, the step d) is not executed and a warning message is displayed (110) on the screen of the device.

5. The method of claim 1, wherein:
the emitter-receiver means of the device comprise emitter-receiver means adapted to operate in a plurality of distinct radio bands corresponding to a plurality of different respective antennas,
the respective entries of said table give the information of relative orientation of the active antenna for each device model liable to be so used for each radio band liable to be used by a given model, and
the step a) of determination of the active antenna comprises the selection, among the plurality of antennas of the device, of the antenna compatible with the radio band used by the emitter-receiver means of the drone.

6. The method of claim 1, wherein it is further provided a previous step of determination of information of relative orientation of the device with respect to the user, and the step d) is conditionally executed as a function of the information of relative orientation of the device with respect to the user.

7. The method of claim 6, wherein the previous step of determination of information of relative orientation of the device with respect to the user is implemented by accelerometer or inclinometer measurement of an absolute orientation of the device body.

8. The method of claim 6, wherein the previous step of determination of information of relative orientation of the device with respect to the user is implemented by detection of the region of the screen surface in contact with the finger(s) of the user holding the device body.
